(19) United States
(12) Patent Application Publication
(10) Pub. No.: US 2025/0229382 A1
(43) Pub. Date: Jul. 17, 2025

(54) INDEX PLATE STRUCTURE

(71) Applicant: PARKSON WU INDUSTRIAL CO., LTD., TAICHUNG CITY (TW)

(72) Inventor: MING HSI WU, TAICHUNG CITY (TW)

(21) Appl. No.: 18/430,904

(22) Filed: Feb. 2, 2024

(30) Foreign Application Priority Data
Jan. 16, 2024 (TW) 113200571

(51) Int. Cl. B25B 5/06

(52) U.S. Cl. CPC B25B 5/06

(57) ABSTRACT

An improved index plate structure includes a base having a drive unit and a worm gear. A bearing device is disposed in the base. The bearing device includes a first retaining seat and a second retaining seat, forming an inner ring of the bearing device, and a rotary disk forming an outer ring of the bearing device. A plurality of rollers are pivoted to the rotary disk. The rollers are driven by the worm gear to rotate the rotary disk and the working disk. A first radial rolling element retainer and a second radial rolling element retainer are disposed between the inner ring and the outer ring of the bearing device. The retainers each have a plurality of rolling elements. The rolling elements are in contact with the rotary disk. The rotary disk forms the outer ring of the bearing device to drive the working disk to rotate.

### FIELD OF THE INVENTION

The present invention relates to an improved index plate structure, and more particularly, to an index plate having fewer components.

### BACKGROUND OF THE INVENTION

Index plates are mainly used in CNC machining centers to clamp a workpiece to rotate, index and position the workpiece for index milling, curved surface machining, circumferential cutting, and linear machining of part of flat surfaces or linear segments.

As shown in FIG. 2, a conventional index plate structure mainly has a hollow base 6, a working disk 62 for clamping a workpiece, and a rotary disk 63 connected to the working disk 62. The rotary disk 63 has a plurality of rollers 631 that are arranged at the same circumferential position and equally spaced and a worm gear 64 meshing with the rollers 631 of the rotary disk 63. The base 6 has a drive unit on one side thereof for driving the worm gear 64 to rotate. The drive unit drives the worm gear 64 and the roller 631 for power transmission to drive the rotary disk 63, so that the working disk 62 can rotate at different angles.

In order to allow the rotary disk 63, the working disk 62 and the base 1 to rotate freely and to bear the axial and radial loads between these components, a rotary disk bearing 7 is provided.

The rotary disk bearing 7 may be in the form of a roller or ball. In order to position a retainer 71 of the bearing, an inner ring 72 and an outer ring 73 of the rotary disk bearing 7 have to be positioned separately. As shown in the figure, the inner ring 72 is non-rotatable and held in place by an inner bottom seat 8 and an inner retaining ring 81, and the inner bottom seat 8 is locked to the base 6. The outer ring 73 is rotatable relative to the inner ring 72. The outer ring 73 is held in place by an outer retaining ring 91. The outer retaining ring 91 connects the rotary disk 63 and the working disk 62. When the worm gear 64 drives the rotary disk 63, the working disk 62 is driven by the rotary disk 63.

However, according to the assembly structure mentioned above, there are too many and complicated components, which increases the material cost and has the disadvantage of increasing the machining and assembly time. Therefore, it is necessary to develop an index plate with a simpler structure.

### SUMMARY OF THE INVENTION

The primary object of the present invention is to provide an improved index plate structure. The index plate structure has fewer components and saves machining and assembly time.

In order to achieve the foregoing object, the improved index plate structure provided by the present invention comprises a hollow base, a worm gear, a bearing device, and a working disk.

The base includes a drive unit therein.

The worm gear is disposed in the base and driven by the drive device to rotate.

The bearing device is disposed in the base. The bearing device includes a first retaining seat, a second retaining seat, and a rotary disk.

The working disk extends out of the base.

The first retaining seat and the second retaining seat are fixed in the base as an inner ring of the bearing device.

The rotary disk forms an outer ring of the bearing device. The rotary disk has a radial surface locked and connected to the working disk. A plurality of rollers are pivotally connected to the rotary disk. The rollers extend outwardly and are spaced equally and arranged radially. The rollers are driven by the worm gear to rotate the rotary disk and drive the working disk.

A first radial rolling element retainer, a second radial rolling element retainer opposite to the first radial rolling element retainer, and an axial rolling element retainer located between the first radial rolling element retainer and the second radial rolling element retainer are disposed between the inner ring and the outer ring of the bearing device. The retainers each have a plurality of rolling elements. The rolling elements are in contact with the rotary disk.

The first retaining seat and the second retaining seat of the bearing device forms the inner ring of the bearing device. The inner ring is fixed to the base. The rotary disk forms the outer ring of the bearing device. The outer ring drives the working disk to rotate.

### BRIEF DESCRIPTION OF THE DRAWINGS

FIG. 1 is a cross-sectional view of a preferred embodiment of the present invention; and

FIG. 2 is a cross-sectional view of a conventional index plate structure.

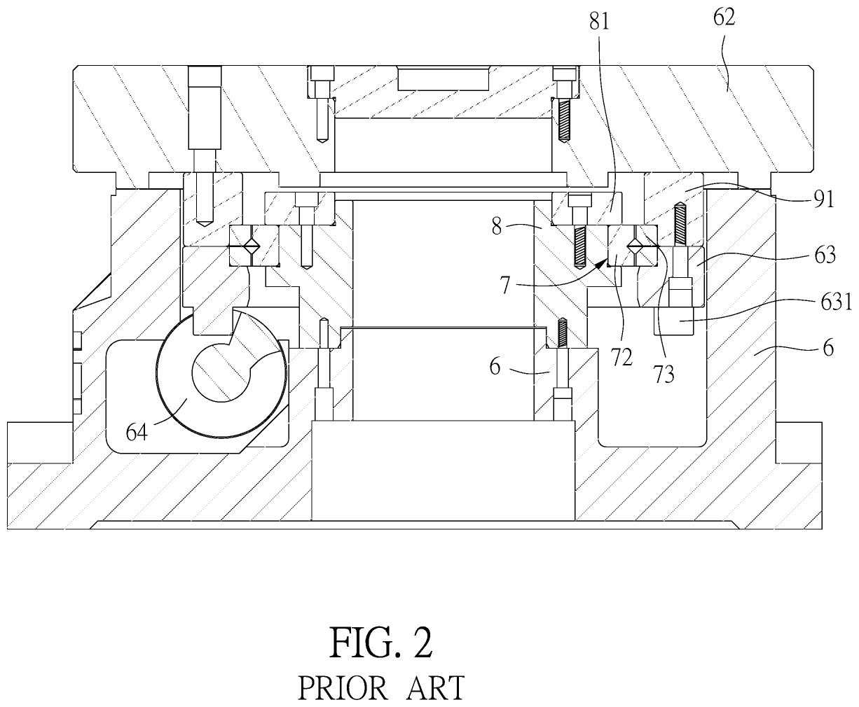

### DETAILED DESCRIPTION OF THE PREFERRED EMBODIMENTS

Embodiments of the present invention will now be described, by way of example only, with reference to the accompanying drawings.

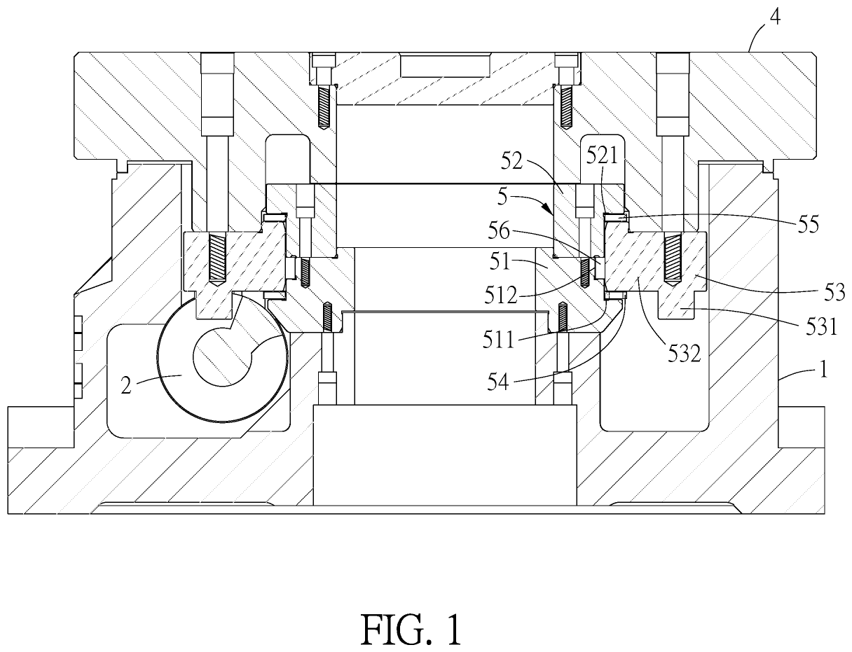

Referring to FIG. 1, the present invention provides an improved index plate structure, comprising a hollow base 1. A drive device (not shown in the figure) is provided on one side of the base 1. The base 1 has a worm gear 2 therein. The drive device drives the worm gear 2 to rotate for power transmission. A working disk 4 is disposed in the base 1 and extends out of the base 1. The working disk 4 is used to clamp a workpiece (not shown in the figure) to be machined.

A bearing device 5 is disposed in the base 1. The bearing device 5 includes a first retaining seat 51, a second retaining seat 52, and a rotary disk 53. The first retaining seat 51, the second retaining seat 52, and the rotary disk 53 are generally in the shape of a circular disk.

The first retaining seat 51 is locked in the base 1. The second retaining seat 52 is axially locked and connected to the first retaining seat 51. Thus, the first retaining seat 51 and the second retaining seat 52 are immobile components fixed in the base 1 and form the inner ring of the bearing device 5. The rotary disk 53 has a radial surface locked and connected to the working disk 4. A plurality of rollers 531 are pivotally connected to the rotary disk 53. The rollers 531 extends outwardly and are spaced equally and are arranged radially. In this embodiment, the rollers 531 are pivoted to another radial surface of the rotary disk 53, facing away from the working disk 4, that is, the rollers 531 are pivoted to the underside of the rotary disk 53 in the figure.

The rotary disk 53 is driven to rotate by the worm gear 2 through the rollers 531, thereby driving the working disk 4. Therefore, the rotary disk 53 forms the outer ring of the bearing device 5.

The bearing device 5 has a plurality of rolling elements. As shown in the figure, a first radial rolling element retainer 54, a second radial rolling element retainer 55 and an axial rolling element retainer 56 are disposed between the inner ring and the outer ring of the bearing device 5.

In this embodiment, the bearing device 5 has rolling cylinders as the rolling elements, therefore, the above-mentioned rolling element retainer are roller retainers.

The outer edge of the first retaining seat 51 has a first mounting portion 511 for mounting the first radial rolling element retainer 54. The outer edge of the second retaining seat 52 has a second mounting portion 521 for mounting the second radial rolling element retainer 55. As shown in the figure of this embodiment, the first mounting portion 511 and the second mounting portion 521 are each an annular radial plane. After assembly, the first radial rolling element retainer 54 and the second radial rolling element retainer 55 are disposed opposite each other. An axial mounting portion 512 is disposed on the outer edge of the first retaining seat 51. The axial mounting portion 512 is an axial annular groove between the first mounting portion 511 and the second mounting portion 521 for mounting the axial rolling element retainer 56.

The rotary disk 53 has a contact portion 532. The contact portion 532 is in contact with the first radial rolling element retainer 54, the second radial rolling element retainer 55 and the axial rolling element retainer 56, so that the rotary disk 53, when driven by the worm gear 2, can rotate smoothly, which in turn drives the working disk 4 to rotate.

According to the present invention, the inner ring of the bearing device 5 is fixed to the base 1, and the outer ring of the bearing device 5 drives the working disk 4 to rotate. That is, the first retaining seat 51 and the second retaining seat 52 forms the inner ring of the bearing device 5, and the rotary disk 53 forms the outer ring of the bearing device 5.

Therefore, the present invention not only omits the outer bottom seat and the outer retaining ring of the rotary bearing of the conventional index plate structure, but also is directly locked with the working disk, making it easy to maintain the required accuracy.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An improved index plate structure, comprising:
a hollow base, including a drive unit therein;
a worm gear, disposed in the base and driven by the drive device to rotate;
a bearing device, disposed in the base, the bearing device including a first retaining seat, a second retaining seat, and a rotary disk;
a working disk, extending out of the base, the working disk being fixed to one end of the rotary disk;
the first retaining seat and the second retaining seat being fixed in the base as an inner ring of the bearing device;
the rotary disk forming an outer ring of the bearing device, the rotary disk having a radial surface locked and connected to the working disk, a plurality of rollers being pivotally connected to the rotary disk, the rollers extending outwardly and being spaced equally and arranged radially, the rollers being driven by the worm gear to rotate the rotary disk and drive the working disk;
a first radial rolling element retainer, a second radial rolling element retainer opposite to the first radial rolling element retainer, and an axial rolling element retainer located between the first radial rolling element retainer and the second radial rolling element retainer being disposed between the inner ring and the outer ring of the bearing device; the retainers each having a plurality of rolling elements, the rolling elements being in contact with the rotary disk;
the first retaining seat and the second retaining seat of the bearing device forming the inner ring of the bearing device, the inner ring being fixed to the base, the rotary disk forming the outer ring of the bearing device, the outer ring driving the working disk to rotate.

2. The improved index plate structure as claimed in claim 1, wherein the first retaining seat, the second retaining seat and the rotary disk are each in the shape of a circular disk.

3. The improved index plate structure as claimed in claim 1, wherein the second retaining seat is axially locked and connected to the first retaining seat.

4. The improved index plate structure as claimed in claim 1, wherein the bearing device has rolling cylinders as the rolling elements.

5. The improved index plate structure as claimed in claim 1, wherein the rollers of the rotary disk are pivoted to one side of the rotary disk, facing away from the working disk.

6. The improved index plate structure as claimed in claim 1, wherein an outer edge of the first retaining seat has a first mounting portion for mounting the first radial rolling element retainer, an outer edge of the second retaining seat has a second mounting portion for mounting the second radial rolling element retainer, the first mounting portion and the second mounting portion are each an annular radial plane, an axial mounting portion is disposed on the outer edge of the first retaining seat, and the axial mounting portion is an axial annular groove between the first mounting portion and the second mounting portion for mounting the axial rolling element retainer.

7. The improved index plate structure as claimed in claim 1, wherein the rotary disk has a contact portion, and the contact portion is in contact with the first radial rolling element retainer, the second radial rolling element retainer and the axial rolling element retainer so that the rotary disk rotates smoothly.
